(19) United States
(12) Patent Application Publication
(10) Pub. No.: US 2014/0256318 A1
(43) Pub. Date: Sep. 11, 2014

(54) BATTERY CONSERVATION WITH IDLE MODE SIGNALING REDUCTION

(71) Applicant: Broadcom Corporation, Irvine, CA (US)

(72) Inventors: Ozgur Ekici, San Diego, CA (US); Ahmed Arsalan, Carlsbad, CA (US)

(21) Appl. No.: 13/866,978

(22) Filed: Apr. 19, 2013

Related U.S. Application Data
(60) Provisional application No. 61/775,393, filed on Mar. 8, 2013.

(51) Int. Cl. H04W 52/02

(52) U.S. Cl. CPC H04W 52/0235
USPC 455/435.1; 455/436

(57) ABSTRACT

Systems and methods are provided that may reduce the battery consumption footprint of a user equipment (UE) in a communications network, such as an LTE network. When a UE is in idle mode, when Idle Mode Signaling Reduction (ISR) is active in the communications network, and when the coverage area of the communications network, such as the LTE network, overlaps with the coverage area of one or more legacy radio access technology (RAT) networks, such as 2G and 3G networks, a module within the UE allows the UE to solely monitor paging messages on the legacy RAT network. Allowing the UE to camp on a legacy RAT network instead of an LTE network to monitor for paging messages can result in lower battery consumption levels when compared to the UE camping on the LTE network.

### TECHNICAL FIELD

The technical field of the present disclosure relates to wireless communications, and in particular, to exploiting the IDLE Mode Signaling Reduction (ISR) feature of the 3^{rd} Generation Partnership Project (3GPP) Long Term Evolution (LTE) standard.

### BACKGROUND

User equipment (UE), e.g., a cellular telephone operating in a wireless communications network, may have various modes of operation that may include an idle mode and a connected mode. In the idle mode, the UE may power down one or more of its operating components/elements for varying periods of time. Powering down one or more of its components assists in conserving battery power (especially as the trend continues to create smaller and smaller electronic devices), as less resources need to be supplied with power. The UE may wake up periodically to monitor paging messages applicable to that UE in case the UE must engage in some activity. Such paging messages may alert the UE to the presence of, e.g., incoming calls, and/or may provide other information. In the connected mode, the UE may actively exchange data with one or more network elements to effectuate, e.g., a voice call or a data call, etc.

A mechanism utilized to control how/when the UE powers down/wakes up may be referred to as discontinuous reception (DRX). That is, the UE may periodically monitor paging messages in accordance with a DRX cycle. The DRX cycle may indicate when the UE should wake up to monitor paging messages (when the UE is in Radio Resource Control (RRC) idle mode, i.e., when the RRC connection is released), and when the UE may power down one or more elements/components to conserve battery life.

Idle mode Signaling Reduction (ISR) refers to a mechanism that allows the UE to remain simultaneously registered in a Universal Terrestrial Radio Access Network (UTRAN)/Global System for Mobile Communications (GSM) Enhanced Data rates for GSM Evolution (EDGE) Radio Access Network (GERAN) Routing Area (RA) and an Evolved UTRAN (E-UTRAN) Tracking Area (TA) list. This can allow the UE to make cell reselections between E-UTRAN and UTRAN/GERAN without the need to send any TA update (TAU) (LTE) or RA update (RAU) (2G/3G) request, as long as the UE remains within those TAs and RAs that are in the registered RA and TA list. Consequently, ISR is a feature that can reduce mobility signaling and improve the battery life of UEs.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example communications network 100 in which various methods and apparatuses may be utilized in accordance with various embodiments;

FIG. 2 illustrates example DRX cycle length periods that may be utilized in the communications network of FIG. 1;

FIG. 3 illustrates an example message flow indicative of paging and data transfer while LTE ISR is active in the communications network of FIG. 1;

FIG. 4 illustrates example processes performed for battery conservation in accordance with various embodiments;

FIG. 5 illustrates an example communications device in accordance with various embodiments; and

FIG. 6 illustrates example processes performed by a computer program product in accordance with various embodiments.

### DETAILED DESCRIPTION

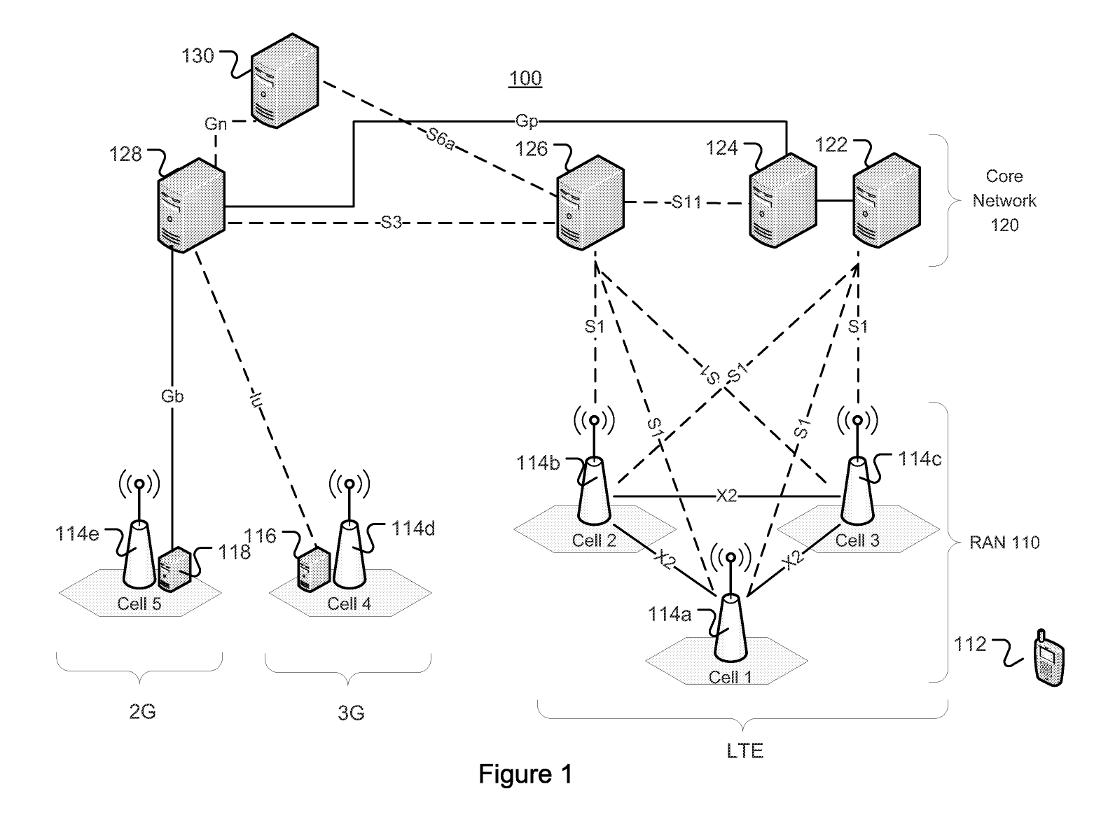

FIG. 1 illustrates an example communications network 100 in which various methods and apparatuses may be utilized in accordance with various embodiments. Communications network 100 may be a network capable of handling a variety of different RATs, such as E-UTRAN (which may also be referred to/used interchangeably herein as LTE), UTRAN (which may also be referred to/used interchangeably herein as 3G), and 2G (which may also be referred to/used interchangeably herein as 2G) communications, for example, and may include a radio area network (RAN) 110 and a core network 120. The RAN 110 may support radio communications for UEs (such as UE 112) within its coverage area. The RAN 110 may be referred to as an E-UTRAN, as it may employ evolved universal mobile telecommunications system (UMTS) terrestrial radio access (E-UTRA) radio technology to communicate with one or more UEs over an air interface. The RAN 110 may also be in communication with the core network 120, where the core network 120 may support various services for the UE 112.

The RAN 110 may include one or more evolved Node Bs (eNBs), which may also be referred to as base stations, Node B's, access points, etc. FIG. 1 illustrates the RAN 110 as including eNBs 114a, 114b, and 114c. It should be noted that the RAN 110 may include any number of eNBs in accordance with various embodiments. The eNBs 114a, 114b, 114c may each include one or more transceivers for communicating with the UE 112 over the aforementioned air interface.

Each of the eNBs 114a, 114b, 114c may be associated with one or more cells (e.g., Cell 1, Cell 2, and Cell 3, respectively), and may be configured to handle radio resource management decisions, handover decisions/mobility management, scheduling of users in the uplink (UL) and/or downlink (DL), etc. Communication between the eNBs 114a, 114b, and 114c may occur over an X2 interface.

The core network 120 may include various network entities, and may separate user plane and control plane traffic. In this example architecture, the core network 120, which may be referred to as an evolved packet core (EPC), can include control and user plane entities. A control plane entity referred to as a Mobility Management Entity (MME) may handle control plane traffic, while user plane traffic may be handled by user plane entities referred to as a Serving Gateway (SGW) and a Packet Data Network (PDN) Gateway (PDN GW or PGW).

The core network 120 may facilitate communications with other networks. For example, the core network 120 may provide access (for the UE 112) to circuit-switched networks, such as the Public Switched Telephone Network (PSTN). The core network 120 may also facilitate communications between the UE 112 and land-line communications devices. For example, the core network 120 may include, or may communicate with, an Internet Protocol (IP) gateway, (e.g., an IP multimedia subsystem (IMS) server), that serves as an interface between the core network 120 and the PSTN. In addition, the core network 120 may provide the UE 112 with access to other networks, which may include other wired or wireless networks that are owned and/or operated by other service providers.

For simplicity, a single SGW 122, a single PGW 124, and one MME 126 are illustrated as being included in the core network 120. The SGW 122 may support data services such as packet data, Voice-over-Internet Protocol (VoIP) communications, video, messaging, etc., and may be connected to each of the eNBs 114a, 114b, and 114c in the RAN 110 via Si interfaces. The SGW 122 may generally route and forward user data packets to/from the UE 112. The SGW 122 may also perform other functions, such as anchoring user planes during inter-eNB handovers, triggering paging when DL data is available for the UE 112, managing and storing contexts of the UE 112, etc.

A PGW (e.g., PGW 124) may be the interface between the LTE “subsystem” and IP networks, which may include, but are not limited to, the public Internet, and Internet Protocol Multimedia Subsystem (IMS) services that may be deployed within an operator core network.

An MME (e.g., MME 126) may be responsible for mobility management and path switching between eNBs at handover. The MME 126 may also perform paging for the core network 120. That is, and as illustrated in FIG. 1, the MME 126 may be connected to each of the eNBs 114a, 114b, and 114c in the RAN 110 via S1 interfaces, and may act as, alluded to above, a control node, while being connected to the PGW 124 via, e.g., an S11 interface. For example, the MME 126 may be responsible for authenticating users of the UE 112, bearer activation/deactivation, selecting a particular SGW during an initial attach procedure of the UE 112, etc. The MME 126 may also provide a control plane function for switching between the RAN 110 and other RANs (not shown) that employ other radio technologies, such as the Global System for Mobile Communications (GSM) standard or the Wideband Code Division Multiple Access (WCDMA) standard. The SGW 122 may be connected to the PGW 124, which may provide the UE 112 with access to packet-switched networks, such as the aforementioned public Internet, to facilitate communications between the UE 112 and other IP-enabled devices.

While each of the foregoing elements are depicted as part of the core network 120, it will be appreciated that any one of these elements may be owned and/or operated by an entity other than the core network operator. Additionally, and in accordance with other embodiments, a pool of MMEs, a pool of PGWs, and a pool of SGWs may make up the core network 120, where an S1-flex mechanism may allow an eNB, such as eNBs 114a, 114b, and/or 114c to connect to the MME, PGW, and SGW pools for load balancing purposes.

It should be noted that the SGW 122, the PGW 124, and/or the MME 126 may communicate with other entities, e.g., remote servers and terminals (not shown). Additionally, other wireless networks may include equivalent network entities. For example, a UTRAN supporting Wireless Code Division Multiple Access (WCDMA)/3G may include the aforementioned node Bs (instead of eNBs) coupled to Radio Network Controllers (RNCs). That is, and in accordance with the 3G standard, a serving general packet radio service (GPRS) support node (SGSN) 128 may be connected to the MME 126 via an S3 interface, and connected to the PGW 124 via a Gp interface. Node B 114d may operate in conjunction with RNC 116, which may be operatively connected to the SGSN 128 via an Iu interface. Similarly, a base transceiver station (BTS) 114e working in conjunction with a base station controller (BSC) 118, which may be connected to the SGSN 128 via a Gb interface, can be used to provide 2G service. A core network for, e.g., UMTS may include Mobile Switching Centers (MSCs), SGSNs, and Gateway GPRS Support Nodes (GGSNs) (instead of SGWs and MMEs). Therefore, the network 100 can support inter-radio access technology (RAT)/multiple RAT communications, mobility, etc.

A home subscriber server (HSS) 130 can be a central database that contains user-related and subscription-related information. The functions of the HSS 130 can include functionalities such as mobility management, call and session establishment support, user authentication and access authorization. Accordingly, the HSS 130 can connect to the SGSN 128 via a Gb interface, and to the MME via an S6a interface.

The UE 112 may communicate with one or more of the eNBs/Node Bs/BTSs 114a-114d, as well as with the SGSN 128, the MME 126, and the SGW 122. The UE 112 may communicate with network entities (e.g., the eNBs 114a, 114b, and 114c) in the RAN 110 via lower layer signaling, and may communicate with network entities (e.g., the MME 126 and the SGW 122) in the core network 120 via upper layer signaling, e.g., Non Access Stratum (NAS) signaling in UMTS/3G and LTE. The UE 112 may also be referred to as a mobile station, a terminal, an access terminal, a subscriber unit, a station, etc., and the UE 112 may be, e.g., a cellular phone, as described above, a personal digital assistant (PDA), a wireless modem, a wireless communication device, a handheld device, a laptop computer, a cordless phone, a wireless local loop (WLL) station, etc. The eNBs 114a, 114b, and 114c may broadcast system information (SI) via a broadcast channel to provide information within various SI types, each of which provides information required by UEs, (e.g., network information (mobile country code (MCC)/mobile network code (MNC) of a network), frequency synchronization parameters, and the like). SI may include the aforementioned NAS and Access Stratum (AS) SI.

As previously alluded to, DRX may be used in mobile communications to conserve the battery life of a UE, such as the UE 112, where during certain periods/time intervals (in an active/awake mode), data transfer may occur, and during other periods/time intervals, the UE 112 may turn its receiver off to enter into a low power state. A DRX cycle may be negotiated by the communications network 100 or sent/defined by the UE 112. In particular, and in accordance with UMTS and LTE standards, the UE 112 may indicate a DRX cycle length to the core network 120 via NAS signaling, e.g., during an attach procedure or a TAU procedure. This DRX cycle length may be specific to the UE 112, and the UE 112 may change the DRX cycle length depending on a particular service being received by the UE 112, a particular device type of the UE 112, and/or other factors. It should be noted that DRX cycle length in the context of various embodiments disclosed herein may refer to “idle mode” DRX cycle length, rather than “connected mode” DRX parameters, such as, e.g., short or long DRX cycle lengths.”

The communications network 100 (e.g., MME 126, and ultimately, a relevant eNB, e.g., eNB 114a, 114b, or 114c) may send paging messages to the UE 112 in accordance with time intervals determined by the DRX cycle. These paging messages may alert the UE 112 to, e.g., incoming calls and/or may be used for other purposes. Alternatively, the communications network 100 may send the DRX cycle(s) over a broadcast channel by defining new SI block (SIB) information.

In particular, the DL Paging Control Channel (PCCH) is used to transmit paging information to UEs, where UEs may be notified of changes in SI, which may, e.g., require a reacquisition of SI. A UE uses DRX in idle mode to reduce battery consumption, as previously described, where a DRX cycle may be configured by certain parameters sent in an SI Block 2 (SIB2). The UE may monitor the PDCCH at certain intervals (set by the DRX cycle parameters) in order to check for the presence of a paging message. That is, the UE utilizes the DRX cycle during idle mode to wake itself up to check for such paging messages. If the PDCCH indicates that a paging message is being transmitted in a subframe, the UE may decode the Physical Downlink Shared Channel (PDSCH) to see if the paging message is directed to that UE. Paging messages may be sent to all eNBs within a TA.

In accordance with the standard(s) specifying paging procedures in the 51 protocol, the MME 126 may initiate a paging procedure by sending a paging message to an applicable eNB, e.g., eNB 114a, 114b, or 114c. Upon receiving the paging message from the MME 126, the relevant eNB (e.g., eNB 114a, 114b, or 114c) may perform paging of the relevant UE in the cell(s) which belong to TAs indicated in the (aforementioned) list of TAs information element (IE) (e.g., the UE 112 in one of more of the Cells 1, 2, and/or 3). For each of the cells (e.g., Cells 1, 2, and/or 3) that belong to any of the TAs indicated in the list of TAs IE, the relevant eNB (e.g., eNB 114a, 114b, or 114c) may generate a page on the radio interface. This paging procedure occurs in accordance with the DRX cycle.

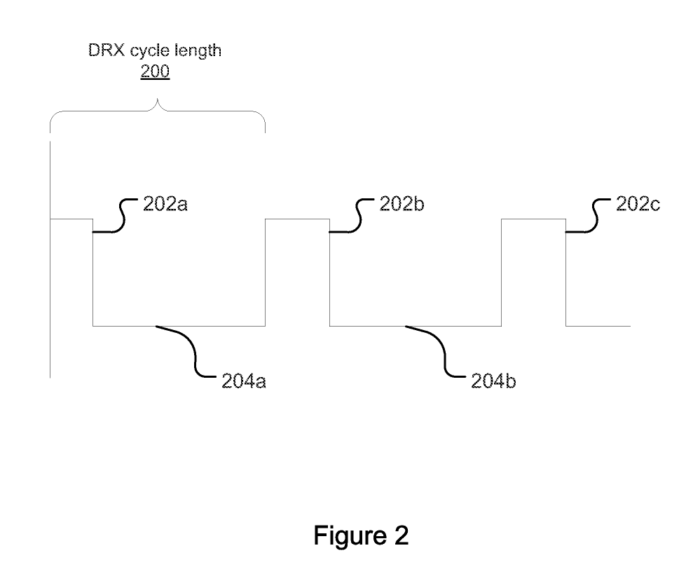

FIG. 2 illustrates an example representation of a DRX cycle length 200 broadcast by an eNB, e.g., eNB 114a. With respect to the DRX cycle length 200, an active/awake mode or duration may be indicated by periods 202a, 202b, and 202c. During these periods, the UE 112 may monitor the PDCCH for paging messages. Idle modes or durations may be indicated by periods 204a and 204b. It is during these idle mode periods 204a and 204b that DRX is utilized, e.g., the receiver of the UE 112 may be turned off. The DRX cycle length 200 includes one active/awake mode period and one idle mode period.

ISR is a feature that allows wireless devices, e.g., UEs, to move between LTE and 2G/3G technologies/networks without performing TAU or RAU procedures once the ISR feature has been activated. As alluded to previously, ISR may be used to limit the signaling between the UE and a network (i.e., the registration procedure) as well as signaling within the network. However, and because the UE does not have to perform registration (i.e., TAU and RAU procedures) while moving back and forth between LTE and 2G/3G networks/RATs, the network remains unaware as to which RAT the UE is camped on at any given time. Therefore, and in order to reach the UE for, e.g., a mobile terminated (MT) call, the network may be forced to page the UE on both LTE and 2G/3G registration areas (i.e., in TAU and RAU order). Accordingly, the cost of utilizing the ISR feature is more complex paging procedures for UEs in ISR, which need to be paged on both the registered RA and all registered TAs, and a HSS may further need to maintain two packet switched (PS) registrations (one from an MME, and another from an SGSN).

Referring back to FIG. 1, and as previously alluded to, a TA can refer to an area in which LTE service can be provided, and may include one or more LTE cells, e.g., cells 1, 2, and 3. An RA can refer to an area in which 2G/3G service can be provided, and in the example communications network 100, may include cells 4 and 5. A TA list can indicate a list of TAs that a UE can enter without performing a TAU procedure, while an RA list can indicate a list of RAs that a UE can enter without performing a RAU procedure.

“Camping on” a cell can refer to an action/state where a UE has completed a cell selection/reselection process and has chosen a cell for which SI and paging information can be monitored. When a UE camps on an E-UTRAN cell, for example, the UE can perform location registration on the MME, and if the UE moves to and camps on a UTRAN/GERAN cell, the UE can perform location registration on the SGSN. Accordingly, and as the UE frequently moves between the E-UTRAN and the UTRAN/GERAN networks/TAs and RAs, the ISR mechanism allows for the UE to respectively perform location registration on the MME and the SGSN (two mobility management nodes) via the E-UTRAN and the UTRAN/GERAN once.

When in idle mode, the UE does not need to perform additional location registration when moving between two pre-registered Radio Access Technologies (RATs), or when reselecting a cell. If there is downlink (DL) data that should be sent to a corresponding UE in an ISR activated state and in idle mode, paging can be simultaneously delivered to the E-UTRAN and the UTRAN/GERAN. This allows the network to successfully search for the UE and to deliver the DL data to the UE.

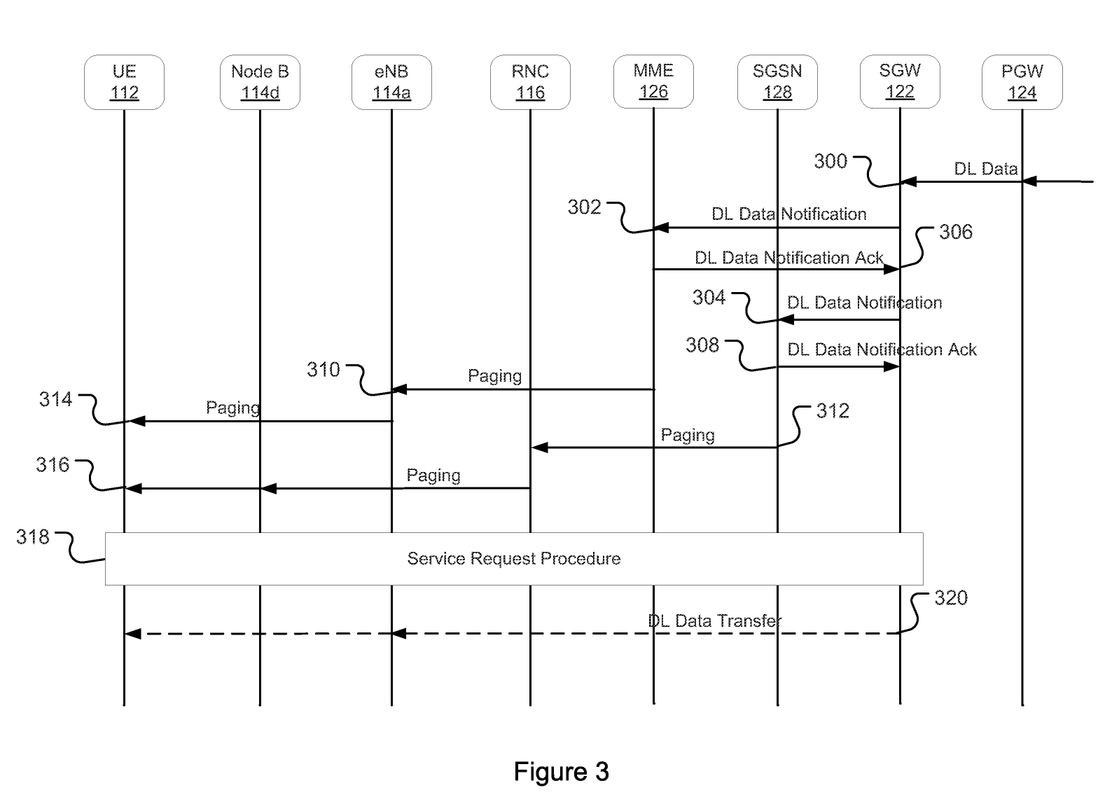

FIG. 3 illustrates an example message flow diagram indicative of paging under ISR when a UE is in idle mode (and camped on an E-UTRAN cell). A PGW, e.g., PGW 124, may receive DL data intended to be transmitted to a UE, e.g., UE 112, by way of an SGW, e.g., SGW 122 at 300. The DL data may be buffered by the SGW 122, while the SGW 122 identifies the appropriate MME serving the UE 112, e.g., MME 126 (as well as determined whether the ISR feature is activate for the UE 112. As described above, the network may be unaware as to whether the UE 112 is camped on a E-UTRAN cell (e.g., cell 1/eNB 114a) or a UTRAN/GERAN cell (e.g., cell 4, Node B 114d), and accordingly, the SGW 122 further determines what SGSN may be serving the UE 112, in this example, SGSN 128. The SGW 122 may then request each of the MME 126 and SGSN 128 to page the UE 112. In particular, a DL data notification message can be sent to the MME 126 and SGSN 128 at 302 and 304, respectively. The MME 126 and the SGSN 128 may respond to the DL data notification message with a DL data notification acknowledgement message transmitted to the SGW 122 at 306 and 308, respectively.

The MME 126 and the SGSN 128 can send a paging message to the UE 112 through each serving access network. In particular, the MME 126 can send a paging message at 310 to each eNB (e.g., eNB 114a) included in the TAs on which the UE 112 has registered, while the SGSN 128 can send a paging message at 312 to the RNC/BSC (e.g., 116). Each eNB that receives the paging message from the MME 126 (e.g., eNB 114a) may page the UE 112 at 314, and the RNC/BSC that received the paging message from the SGSN 128 (e.g., RNC 116) may page the UE 112 at 316.

As described above, it may be assumed for purposes of this example that the UE 112 is camped on an E-UTRAN cell, e.g., eNB 114a. Accordingly, the UE 112 can respond to the paging received from the MME 126 via the E-UTRAN, and can initiate a Service Request Procedure, thereby setting up a user plane as a path at 318. The SGW 122 may then transfer the DL data intended for the UE 112 to the UE 112 at 320. Alternatively, and if the UE 112 is camped on a UTRAN/GERAN cell, e.g., cell 4/Node B 114d, rather than the E-UTRAN cell, the UE 112 can respond to paging received via the UTRAN/GERAN (by way of the SGSN 128 and the RNC 116), and if a user plane is set in the Service Request Procedure, the DL data transfer can occur to the UE 112 from the SGW 122.

Although the ISR and DRX features of LTE provide some mechanisms for combating excessive battery consumption, the idle mode battery consumption footprint of a UE camped on an E-UTRAN can be much higher than if the UE is camped on a UTRAN/GERAN. It should be noted that conventionally, in a communication environment in which a UE is covered by a plurality of RATS (e.g., LTE and 3G; or LTE and 2G), the UE of the legacy RAT (e.g., 2G or 3G) may typically camp on the LTE network. Hence the UE can be consuming more battery power in idle mode operation (i.e., standby). In today's commercial networks, studies have shown that idle mode battery consumption on LTE can be as much as 30 percent higher than on 2G/3G. For example, it has been observed that a UE camped on a commercial 2G network may have a standby battery consumption level of 6.6 mA. Camped on a commercial 3G network, the same UE may have a standby battery consumption level of 5.7 mA. Camped on a commercial LTE network, the standby battery consumption may be 8.1 mA. It should be noted that the standby battery consumption levels provided herein are merely examples. Although in general, standby battery consumption levels are higher in LTE networks as compared to 2G or 3G networks, specific standby battery consumption levels can differ depending on the particular UE (e.g., type, make, intended use, etc.) being utilized, and/or the particular network.

Accordingly, various embodiments leverage the ISR feature when a UE is in overlapping coverage, i.e., when LTE and 2G/3G coverage overlaps within a service area. That is, when both 2G/3G and LTE RATs are available to a UE, the UE need only monitor the paging channel of a UTRAN/GERAN cell for, e.g., MT calls, such as voice calls, email messages, etc., while in idle mode. The UE can monitor the UTRAN/GERAN cell paging channel without risking missing a page because, as previously described, the ISR feature accounts for the lack of knowledge regarding the precise location of a UE by performing paging on both E-UTRAN and UTRAN/GERAN networks.

Therefore, and because a UE can camp onto a UTRAN/GERAN cell while in idle mode as opposed to camping on an E-UTRAN cell, its battery consumption footprint can be reduced, for example, by 30 percent. Hence, a UE that is registered on multiple RATs, e.g., 2G/3G and LTE at the same time, has the liberty to select which network cell to camp on, as well as which network to establish a connection with on the uplink (UL), all while remaining compliant with LTE standards. The ability to camp on a network that has the best battery efficiency, in addition to the ability to establish a connection with the fastest network (to complete MT or initiate mobile originated (MO) calls) can be advantageous for the UE, as the UE can preserve battery life without experiencing performance degradation.

Regarding cell selection/re-selection during idle mode, a UE may maintain the two registrations (E-UTRAN and UTRAN/GERAN) and run timers for the two registrations. Furthermore, the UE can store MM parameters from the SGSN (e.g., P-TMSI and RA) and the MME (e.g., GUTI and TA(s)), as well as session management (bearer) contexts common to E-UTRAN and UTRAN/GERAN. In idle mode, the UE may reselect between E-UTRAN and UTRAN/GERAN within the registered RA and TAs (without performing TAU and RAU procedures as previously described), while the SGSN and MME store each other's respective address when ISR is activated.

That is, and when a UE is initially switched on, a public land mobile network (PLMN) may be selected by NAS, and for the selected PLMN, an associated RAT may be set. With cell selection, the UE can search for a suitable cell of the selected PLMN, choose that cell to provide available services, and further shall tune to the cell's control channel, i.e., the aforementioned “camping on the cell.” The UE may, if necessary, register its presence, by way of a NAS registration procedure, in the TA of the chosen cell. If the UE finds a more suitable cell, according to cell reselection criteria, the UE may reselect onto that more suitable cell, and camp on it. If the new cell does not belong to at least one TA to which the UE is registered, location registration is performed. If necessary, the UE may search for higher priority PLMNs at regular time intervals, and search for a suitable cell if another PLMN has been selected by NAS, while a search for available closed subscriber groups (CSGs) may be triggered by NAS to support manual CSG selection. If the UE loses coverage of the registered PLMN, either a new PLMN may be selected automatically (automatic mode), or an indication of which PLMNs are available is given to a user, so that a manual selection can be made (manual mode).

To effectuate cell selection and reselection, the UE can perform various measurements upon which cell selection and reselection may be based, where the NAS can control the RAT(s) in which the cell selection should be performed, for instance by indicating RAT(s) associated with the selected PLMN, and by maintaining a list of forbidden registration area(s) and a list of equivalent PLMNs. The UE can then select a suitable cell based on idle mode measurements and cell selection criteria. In order to speed up the cell selection process, stored information for several RATs may be available in the UE. When camped on a cell, the UE may regularly search for a better cell according to the cell reselection criteria. If a better cell is found, that cell is selected. The change of cell may imply a change of RAT.

For normal service, the UE may camp on a suitable cell, tune to that cell's control channel(s) so that the UE can, e.g., receive system information from the PLMN; receive registration area information from the PLMN, e.g., TA information; receive other AS and NAS Information; and if registered: receive paging and notification messages from the PLMN; and initiate transfer to connected mode. The various rules, states, measurements, criteria, etc. upon which cell selection and reselection can be based may include, but are not limited to, for example, cell ranking in a hierarchical cell structure architecture, cell priority, quality level threshold criterion, cell selection RX levels, maximum TX power level a UE may use when accessing a cell, etc.

It should be noted that the same or similar processes may be performed in the UTRAN/GERAN context as specified in the respective standards that specify UE procedures in idle mode.

Such processes/methods can be manipulated in accordance with various embodiments such that the UE camps on a legacy RAT, e.g., a cell in a UTRAN/GERAN, while in idle mode and when ISR is active to allow for the aforementioned monitoring of paging messages thereon to avoid the higher battery power penalties associated with idle mode battery consumption while being camped on a cell in an E-UTRAN. For example, in the UTRAN case, when returning to idle mode from connected mode, the UE may conventionally select a suitable cell to camp on. Candidate cells for this selection are the cell(s) used immediately before leaving connected mode. If no suitable cell is found, the UE can use a stored information cell selection procedure in order to find a suitable cell to camp on. When returning to idle mode after, e.g., an emergency call on any PLMN, the UE may select an acceptable cell to camp on. Candidate cells for this selection may be the cell(s) used immediately before leaving connected mode. If no acceptable cell is found, the UE can continue to search for an acceptable cell of any PLMN. It should be noted that the UE can be aware of when ISR is active by receipt of an ISR indication information element (IE) included in a TAU accept or RAU accept message.

In accordance with various embodiments, a software module/instructions may be utilized to allow the UE to override such cell selection/reselection processes, if necessary, to ensure that the UE is camped on a legacy RAT network during idle mode when ISR is active. That is, relevant SI received by the UE in a particular SIB can be overwritten, superseded, and/or ignored. Therefore, if, for example, the network suggests that the UE camp on an E-UTRAN cell, the software module/instructions operative within the UE may determine that ISR is active, and instead, instruct the UE to camp on a UTRAN/GERAN cell.

For example, the UE may receive SIBs, e.g., SIB3, SIB5, and SIB6 SI broadcast by the network, where a PLMN can be selected based on RAT priorities of PLMNs included in the SIB3, or an initial/current PLMN may be maintained. SIB3 may include the absolute priority of a serving cell, SIB5 may include the absolute priority of each LTE frequency, and SIB6 may include the absolute priority of each UMTS frequency. Based on the absolute priorities gleaned from the SIB3, SIB5, and SIB6 SI, the UE can determine to select or reselect, e.g., a UTRAN cell or an E-UTRAN cell, the selection/reselection further being based on, e.g., inter-RAT measurements, such as cell selection RX level and quality values. That is, and when an LTE frequency has a higher absolute priority than the serving cell, the UE should reselect an E-UTRAN cell at this frequency if other conditions for E-UTRAN cell reselection (alluded to previously) are also met.

However, and in accordance with various embodiments, this cell reselection to an E-UTRAN cell can be overridden, superseded, and/or ignored by the UE, where the UE may instead camp on a UTRAN/GERAN cell during idle mode. That is, if serving cell is an E-UTRAN cell, the UE may reselect to a UTRAN/GERAN cell. If the serving cell is a UTRAN/GERAN cell, the UE can remain camped on the serving cell despite the E-UTRAN cell having a higher absolute priority, for example.

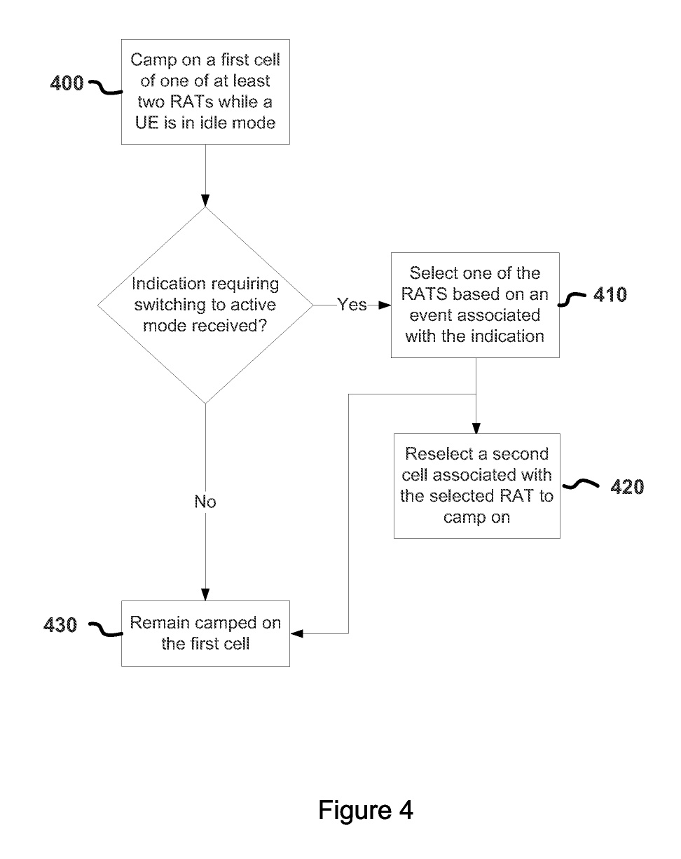

FIG. 4 illustrates example processes performed in accordance with various embodiments for reducing battery consumption during idle mode in conjunction with ISR. At 400, a first cell of one of at least two RATs is camped on while a UE is in idle mode. That is, and as described above, a UE, e.g., a multi-mode UE capable of operating in an LTE as well as legacy network, such as 2G/3G, may be instructed or allowed to camp on and monitor the paging channel of the legacy network only, instead of the LTE network when the UE is in idle mode, ISR is active in the LTE network, and coverage areas of the LTE and 2G/3G networks overlap. Allowing the UE to camp on the legacy network enables the UE to experience increased/better battery conservation than if the UE were to camp on an LTE network. While in idle mode, the UE can receive an indication requiring the UE to switch to active or connected mode. If such an indication is received (e.g., a paging message indicative an MT call) one of the RATS is selected based on an event, i.e., the MT call, that is associated with the indication, i.e., paging message at 420. At 430, a second cell associated with the RAT is reselected to camp on. If there is no indication received requiring the UE to switch to active or connected mode, the UE remains camped on the first cell at 440.

As previously described, the UE may remain camped on the first cell, or the UE may tune to another cell. For example, if the MT call is associated with a multimedia-type communication that requires or is preferably handled with a high bandwidth/data rate, the UE may wish to camp on the LTE network, and therefore, selects the LTE network to complete the MT call. If on the other hand, the MT call does not require high data rates, e.g., textual email, the UE can remain camped on the 2G/3G network.

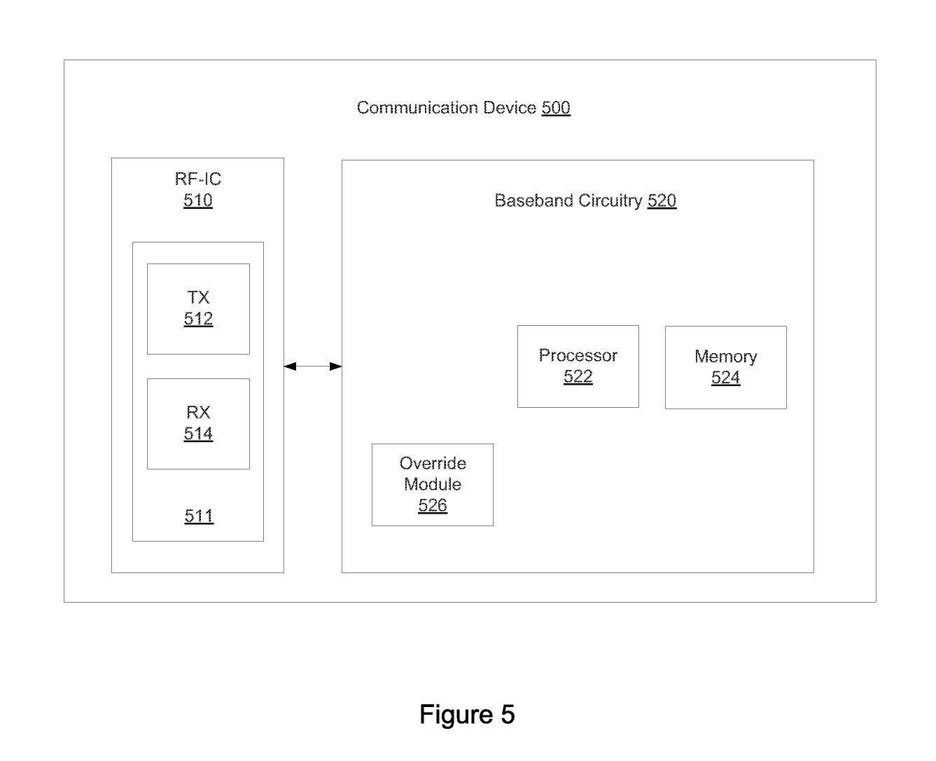

FIG. 5 is a block diagram of an example communication device 500, which may be an embodiment of the UE 112 of FIG. 1. The communication device 500 may include radio frequency (RF) circuitry 510 connected to baseband circuitry 520. The RF circuitry 510 can include a radio transceiver module 511 for transmitting and receiving RF signals and interfaces, e.g., via a duplex filter, with an RF antenna module(s) of the device. The RF circuitry 510 can include an RF transmitter (TX) 512 that transmits signals to one or more neighboring cells, e.g., cells 1-5 in a wireless network. The RF circuitry 510 also can include an RF receiver (RX) 514 that receives signals broadcast from one or more neighboring cells, e.g., cells 1-5. The transmitter 512 and receiver 514 may include various RF components, such as amplifiers, filters, local oscillators and mixers/modulators. In operation, the RF transmitter 512 can modulate and up-convert a baseband signal from the baseband circuitry 520 onto an RF carrier generated by a local oscillator within the RF transmitter 512 for RF transmission. Further, the RF receiver 514 may filter and down-convert received RF signals into a signal to be processed by the baseband circuitry 520. The RF transmitter 512 and the RF receiver 514 may be independently turned on-and-off based on a mode of operation of the communication device 500 (e.g., in compliance with DRX and/or ISR). In some implementations, a single transceiver unit can replace the separate RF transmitter 512 and RF receiver 514, and in still other implementations, multiple transmitters, receivers, transceivers, and/or antennas may be used to support multiple RATs.

The baseband circuitry 520 may provide digital signal processing and control functions within the communication device 500. The baseband circuitry 520 can include a receive baseband module (not shown) that filters and converts the analog signal received from the RF receiver 514 into a digital signal for further processing. The baseband circuitry 520 may also include a transmit baseband module (not shown) that processes and converts a digital baseband signal into an analog signal that can be transmitted to the RF transmitter 512.

The baseband circuitry 520 can control the RF circuitry 510 to selectively turn either or both of the RF transmitter 512 and the RF receiver 514 on/off based on a mode of operation implemented by the communication device 500. In addition, either or both of the baseband circuitry 520 and the RF circuitry 510 can be turned on/off based on a mode of operation. For example, in a normal mode of operation, both the RF circuitry 510 and the baseband circuitry 520 can be turned on to establish a connection with one of the neighboring cells, e.g., to download data through the established connection and to process the downloaded data. In a DRX or ISR mode of operation, the baseband circuitry 520 can turn the RF circuitry 510 on to monitor signals (e.g., paging messages) broadcast by the one or more neighboring cells, e.g., cells 1-5. Then, the baseband circuitry 520 can turn the RF circuitry off to reduce power consumption while the baseband circuitry 520 processes the received signals. In some implementations, the RF circuitry 510 can be turned on for a portion of the time when the baseband circuitry 520 is turned on to process the received signals.

To support various functions of the baseband circuitry 520, a processor 522 and memory 524 can be included to interface with and control operation of other components of the baseband circuitry 520. As an example, baseband circuitry 520 can be used to decode monitored signals received through the RF circuitry 520, e.g., to identify the single frequency network corresponding to each neighboring cell, and may be configured to support LTE, 2G, 3G, etc. standards. The decoded signals or the raw monitored signals can be stored in a memory component 524. Various types of Random Access Memory (RAM) devices, Read Only Memory (ROM) devices, Flash Memory devices, and other suitable storage media can be used to implement the memory component 524. In addition, the memory component 524 can store other information and data, such as instructions, software, values, and other data processed or referenced by the processor 522.

Various components of the baseband circuitry 520 can be selectively turned on-and-off, either as a group or individually, to efficiently use the chip resources for handling various processing tasks while reducing overall chip power consumption. The processor 522 can control various operations of the remaining components in the baseband circuitry 520, including selectively turning these components on-and-off to support a particular mode of operation.

An override module 526 can be utilized, as described above, to control/direct the communication device 500 with regard to responding to instructions from the network regarding cell selection/reselection. In particular, the override module 526 can override the network and/or allow the communication device 500 to ignore the network, and camp on a legacy RAT network, such as a 2G or 3G neighboring cell while in idle mode, and while ISR is active.

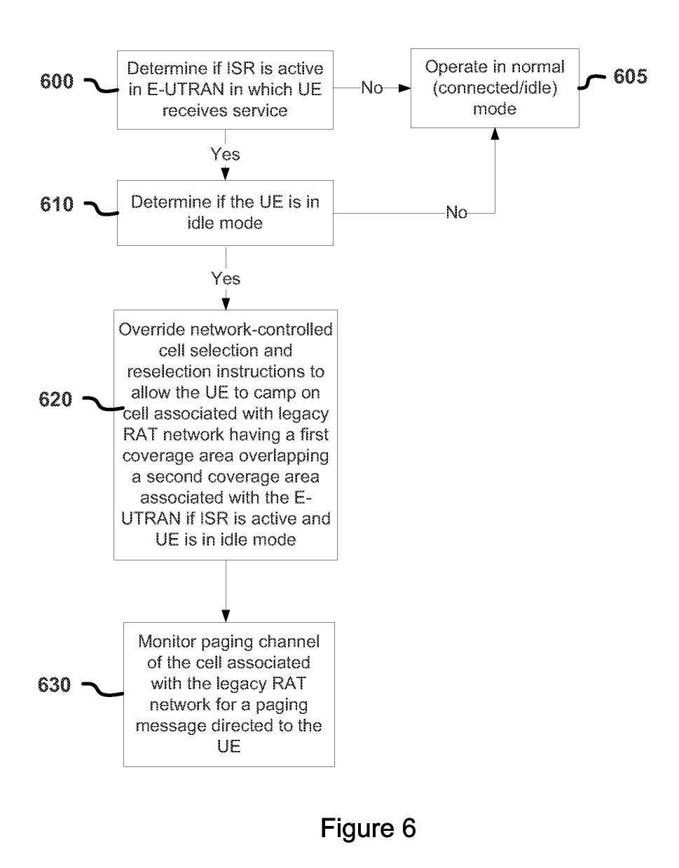

FIG. 6 illustrates example processes performed by a computer program product, embodied on a non-transitory computer-readable medium in accordance with various embodiments. As previously described, a module, e.g., override module 526 of FIG. 5, may be configured to override network-controlled cell selection/reselection. Accordingly, the computer program product may include computer code for determining if ISR is active in an E-UTRAN in which a UE receives service at 600. If ISR is not active, the UE can operate in “normal” mode, (whether connected or idle) in accordance with, e.g., the LTE standard, at 605. The computer program product may further include computer code for determining if the UE is in idle mode at 610. Again, if the UE is not in idle mode, it can operate in normal, connected mode at 605. Further still, the computer program product can include computer code for overriding network-controlled paging and cell selection and reselection instructions to allow the UE to camp on a cell associated with a legacy RAT network having a first coverage area overlapping a second coverage area associated with the E-UTRAN if ISR is active and the UE is in idle mode at 620. Once the UE is camped on the legacy RAT network cell, the UE can monitor paging messages on the legacy RAT network cell rather than on the E-UTRAN as previously described. Accordingly, the computer program product can include computer code for monitoring a paging channel of the cell associated with the legacy RAT network only, for a paging message directed to the UE at 630.

In accordance with various embodiments, power consumption in a UE may be reduced, not only by reducing the amount of TAUs and RAUs that are initiated which require system resources to be utilized, but by adjusting the behavior of UE in idle mode to camp on legacy RATs, such as UTRAN/GERAN cells, where battery consumption can be, e.g., 30 percent less than when camping on a E-UTRAN cell. Various embodiments have been described in the context of LTE, 2G, and 3G networks and standards. However, it should be noted that the mechanisms described herein for leveraging existing features, such as ISR, may be applied to other types of communication technologies and/or networks that may allow for flexibility as to what RAT/cell a UE can camp on to allow the UE to camp on a less-power-intensive RAT/cell.

The various diagrams illustrating various embodiments may depict an example architectural or other configuration for the various embodiments, which is done to aid in understanding the features and functionality that can be included in those embodiments. The present disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement various embodiments. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

It should be understood that the various features, aspects and/or functionality described in one or more of the individual embodiments are not limited in their applicability to the particular embodiment with which they are described, but instead can be applied, alone or in various combinations, to one or more of the other embodiments, whether or not such embodiments are described and whether or not such features, aspects and/or functionality is presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Moreover, various embodiments described herein are described in the general context of method steps or processes, which may be implemented in one embodiment by a computer program product, embodied in, e.g., a non-transitory computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

As used herein, the term module can describe a given unit of functionality that can be performed in accordance with one or more embodiments. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. Where components or modules of the invention are implemented in whole or in part using software, in one embodiment, these software elements can be implemented to operate with a computing or processing module capable of carrying out the functionality described with respect thereto. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
camping on a first cell of one of at least two radio access technologies (RATs) while a UE is in idle mode;
upon receiving an indication requiring exiting idle mode, selecting one of the RATs based on an event associated with the received indication; and
remaining camped on the first cell if the selected RAT is associated with the first cell or reselecting a second cell of the selected RAT to camp on.

2. The method of claim 1, wherein the first cell of one of the at least two RATs comprises a cell associated with a legacy RAT.

3. The method of claim 2, wherein the legacy RAT comprises one of a Global System for Mobile Communications Radio Access Network (GERAN) and Universal Terrestrial Radio Access Network (UTRAN).

4. The method of claim 1, wherein the indication comprises a paging message.

5. The method of claim 1, wherein the event comprises a mobile terminated call.

6. The method of claim 5, wherein the selection of the one of the RATs is further based on a preferred data rate for completing the mobile terminated call.

7. The method of claim 1, wherein the selected RAT comprises an evolved UTRAN (E-UTRAN).

8. The method of claim 1, wherein the UE is registered in each of the two RATs, and wherein Idle Mode Signaling Reduction (ISR) is active.

9. An apparatus, comprising:
radio frequency (RF) circuitry to support communication with a plurality of radio access technology (RAT) network cells; and
a module for controlling selection and reselection of the plurality of RAT network cells while the UE, such that the UE camps on one of the plurality of RAT network cells providing a lower battery consumption footprint for the UE while the UE is in idle mode.

10. The apparatus of claim 9, wherein the plurality of RAT network cells comprises at least one cell associated with a long term evolution (LTE) network and at least one cell associated with at least one of a 2^{nd} Generation (2G) wireless communication network and a 3^{rd} Generation (3G) wireless communication network.

11. The apparatus of claim 10, wherein the one of the plurality of RAT network cells providing the lower battery consumption footprint comprises one of the 2^{nd} Generation (2G) wireless communication network and the 3^{rd} Generation (3G) wireless communication network.

12. The apparatus of claim 10, wherein the module overrides network-controlled selection and reselection of the plurality of RAT network cells when the network-controlled selection and reselection directs the UE to camp on the LTE network when idle mode signaling reduction (ISR) is active within the LTE network.

13. The apparatus of claim 12, wherein the module overrides the network-controlled selection and reselection of the plurality of RAT network cells pursuant to the apparatus completing registration in the LTE network and at least one of the 2G and 3G networks.

14. The apparatus of claim 12, wherein the module overrides the network-controlled selection and reselection of the plurality of RAT network cells when coverage areas associated with the plurality of RAT network cells overlap.

15. The apparatus of claim 12, wherein the network-controlled selection and reselection of the plurality of RAT network cells overrides the module when the apparatus switches to a connected mode from idle mode.

16. A computer program product, embodied on a non-transitory computer-readable medium, comprising:
computer code for determining if idle mode signaling reduction (ISR) is active in an evolved Universal Terrestrial Radio Access Network (E-UTRAN) in which a user equipment (UE) receives service;
computer code for determining if the UE is in idle mode;
computer code for overriding network-controlled paging and cell selection and reselection instructions to allow the UE to camp on a cell associated with a legacy radio access technology (RAT) network having a first coverage area overlapping a second coverage area associated with the E-UTRAN if ISR is active and the UE is in idle mode; and
computer code for monitoring a paging channel of the cell associated with the legacy RAT network only, for a paging message directed to the UE.

17. The computer program product of claim 16, wherein the paging message is indicative of a downlink data transfer intended for the UE.

18. The computer program product of claim 17 further comprising, computer code for determining whether to complete the downlink data transfer over the E-UTRAN or the legacy RAT network based on a preferred data rate for completing the downlink data transfer.

19. The computer program product of claim 16, wherein the legacy RAT network comprises at least one of a UTRAN and a Global System for Mobile Communications (GSM) Enhanced Data rates for GSM Evolution (EDGE) Radio Access Network (GERAN).

20. The computer program product of claim 16 further comprising, computer code for allowing the E-UTRAN to control cell selection and reselection when the UE is in connected mode.
